(19) United States
(12) Patent Application Publication
(10) Pub. No.: US 2014/0172586 A1
(43) Pub. Date: Jun. 19, 2014

(54) ADVERTISEMENT INFORMATION PROVIDING DEVICE AND ADVERTISEMENT INFORMATION PROVIDING METHOD

(71) Applicant: YAHOO JAPAN CORPORATION, Tokyo (JP)

(72) Inventor: Masashi TSUBOSAKA, Tokyo (JP)

(73) Assignee: YAHOO JAPAN CORPORATION, Tokyo (JP)

(21) Appl. No.: 13/958,045

(22) Filed: Aug. 2, 2013

(30) Foreign Application Priority Data
Dec. 18, 2012 (JP) 2012-275223

(51) Int. Cl. G06Q 30/02

(52) U.S. Cl. CPC G06Q 30/0273
USPC 705/14.69

(57) ABSTRACT

An advertisement information providing device includes an advertisement content storing unit which stores impression-guaranteed type advertisement content and time basis billing type advertisement content, an advertisement content determining unit which, when receiving a page browsing request from a terminal device of a user, determines advertisement content to be delivered from the impression-guaranteed type advertisement content and the time basis billing type advertisement content stored in the advertisement content storing unit, and an advertisement content delivering unit which delivers the advertisement content determined by the advertisement content determining unit to an ad space included in a page for which the page browsing request is received from the terminal device of the user.

### CROSS-REFERENCE TO RELATED APPLICATIONS

The present application claims priority to and incorporates by reference the entire contents of Japanese Patent Application No. 2012-275223 filed in Japan on Dec. 18, 2012.

### BACKGROUND OF THE INVENTION

1. Yield of the Invention

The present invention relates to a technology which provides advertisement information through a network.

2. Description of the Related Art

Advertisement which is provided through a network has several billing options, for example, an impression-guaranteed type and a time basis billing type.

The impression-guaranteed type guarantees an advertiser to present the advertisement with a predetermined number of impressions (i.e., number of presentations) within a predetermined period and the fee is charged in a lump sum under a condition that the predetermined number of advertisement presentations has been performed.

In the time basis billing type, the fee is calculated in accordance with a length of the time advertisement is displayed (time after a screen of a page including the advertisement is displayed until the page displayed on the screen is changed or the screen is closed). There are various billing types in the time basis billing type, for example: a method in which the billing amount increases linearly or curvedly along with the increase in the display time, a method in which the billing amount is zero when the display time is shorter than a predetermined time and the fee is charged when the display time exceeds the predetermined time, or a method combining these two methods.

In general, in the impression-guaranteed type, since the number of impressions is large, the billing amount per each advertisement presentation is small; but in the time basis billing type, the billing amount when the display time exceeds a predetermined time is much larger than the billing amount for one advertisement presentation of the impression-guaranteed type.

In the conventional technology, a billing type is determined in advance for each ad space on the page. Hence, only the impression-guaranteed type advertisement is displayed on the impression-guaranteed type ad space and only the time basis billing type advertisement is displayed on the time basis billing type ad space.

The applicant could not find a publicly available document related to the present invention by the time of filing of the application. Therefore, no information is provided herein with regard to the related documents.

As described above, since the billing type is fixed for each ad space in the conventional technology, the impression-guaranteed type ad space is used only to increase the number of advertisement presentations. The time basis billing type advertisement whose billing amount is large cannot be presented on the ad space dedicated for the impression-guaranteed type advertisement. Thus, the increase in profit is limited.

### SUMMARY OF THE INVENTION

According to one aspect of an embodiment, an advertisement information providing device includes: an advertisement content storing unit which stores impression-guaranteed type advertisement content and time basis billing type advertisement content; an advertisement content determining unit which, when receiving a page browsing request from a terminal device of a user, determines advertisement content to be delivered from the impression-guaranteed type advertisement content and the time basis billing type advertisement content stored in the advertisement content storing unit, and an advertisement content delivering unit which delivers the advertisement content determined by the advertisement content determining unit to an ad space included in a page for which the page browsing request is received from the terminal device of the user.

According to another aspect of an embodiment, a method which is executed by an advertisement information providing device, the method includes: storing impression-guaranteed type advertisement content and time basis billing type advertisement content; determining, when receiving a page browsing request from a terminal device of a user, an advertisement content to be delivered from the impression-guaranteed type advertisement content and the time basis billing type advertisement content stored in the storing of the advertisement content; and delivering the advertisement content determined in the determining of the advertisement content to an ad space included in a page for which the page browsing request is received from the terminal device of the user.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating a configuration example of a system according to an embodiment of the present invention;

FIG. 2 is a diagram illustrating a structural example of data of an advertisement DB (Database);

FIG. 3 is a diagram illustrating a structural example of data of a behavior history DB;

FIG. 4 is a diagram illustrating a structural example of data of an ad space DB;

FIG. 5 is a sequential diagram (part 1) illustrating a processing example of an embodiment; and

FIG. 6 is a sequential diagram (part 2) illustrating a processing example of an embodiment.

### DETAILED DESCRIPTION OF THE PREFERRED EMBODIMENTS

Hereinafter, preferred embodiments of the present invention will be described.

Configuration

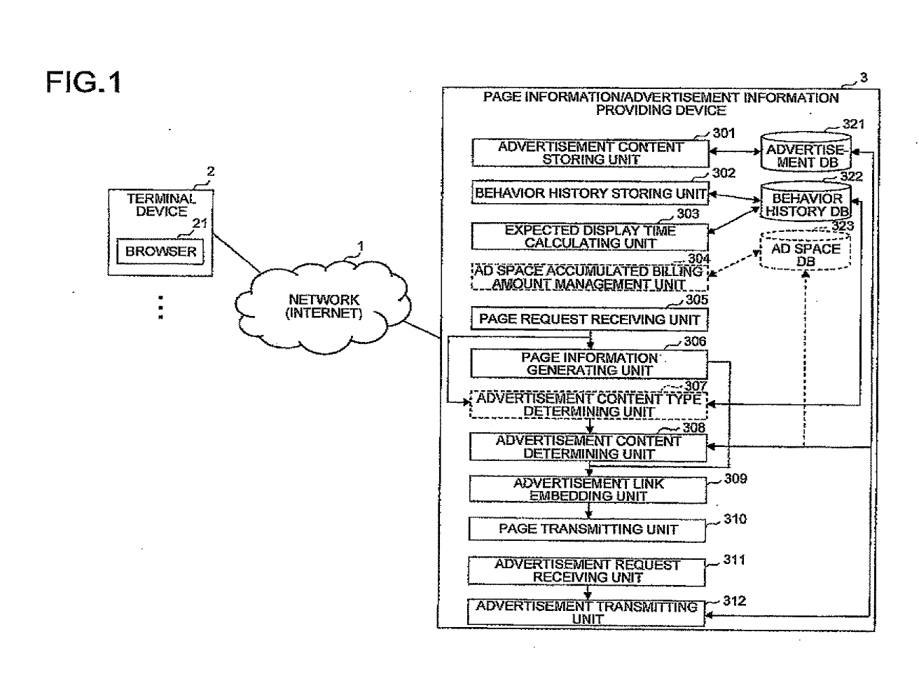

FIG. 1 is a diagram illustrating a configuration example of a system according to an embodiment of the present invention.

In FIG. 1, a plurality of terminal device 2, such as a smart phone, a cellular phone, or a personal computer (PC) which is manipulated by a user, are connected to a network 1 such as the Internet. The terminal device 2 includes a general browser (web browser) 21. The browser 21 has functions to request, obtain, and display page data described by a language such as Hyper Text Markup Language (HTML) and transmit form data, in accordance with Hyper Text Transfer Protocol (HTTP) which is a standard protocol of the Internet.

Further, a page information/advertisement information providing device 3 which provides page information and advertisement information in response to a request from the terminal device 2 is connected to the network 1.

The page information/advertisement information providing device 3 includes an advertisement content storing unit 301, a behavior history storing unit 302, an expected display time calculating unit 303, an ad space accumulated billing amount management unit 304, a page request receiving unit 305, a page information generating unit 306, an advertisement content type determining unit 307, an advertisement content determining unit 308, an advertisement link embedding unit 309, a page transmitting unit 310, an advertisement request receiving unit 311, and an advertisement transmitting unit 312, as functional units.

These functional units are implemented by a computer program which is executed on hardware resources such as a central processing unit (CPU), a read only memory (ROM), and a random access memory (RAM) of a computer which constitutes the page information/advertisement information providing device 3. These functional units do not need to be disposed on a single computer but may be distributed if necessary.

Further, as a database which is used by the page information/advertisement information providing device 3, an advertisement DB 321, a behavior history DB 322, and an ad space DB 323 are installed. These databases systematically store predetermined data on a storage medium such as a hard disk drive (HDD) in the computer which constitutes the page information/advertisement information providing device 3. Further, the advertisement DB 321, the behavior history DB 322, and the ad space DB 323 do not need to be disposed in the page information/advertisement information providing device 3, but may be disposed in other devices. Further, the advertisement content includes impression-guaranteed type advertisement content and time basis billing type advertisement content, which will be described below. In general, the impression-guaranteed type advertisement content and the time basis billing type advertisement content are submitted in different manners, and hence, the advertisement DB 321 may be divided depending on the types of advertisement contents.

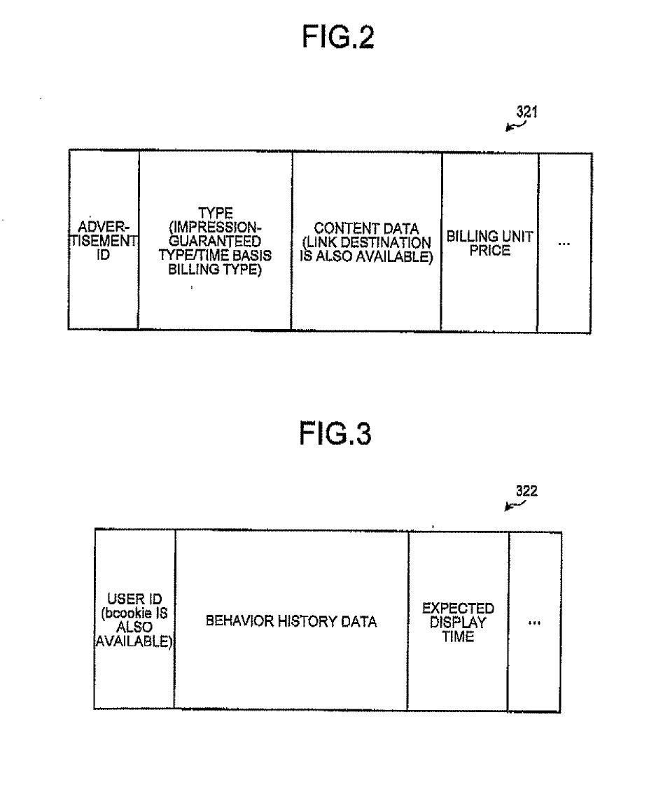

FIG. 2 is a diagram illustrating a structural example of data of the advertisement DB 321, which includes items (fields) such as an “advertisement ID”, a “type”, “content data”, and “billing unit price”. The “advertisement ID” is information which specifies the advertisement content. The “type” is information indicating a type of the advertisement contents in this embodiment, the “type” indicates whether the advertisement content is impression-guaranteed type advertisement content or time basis billing type advertisement content. The “content data” is link information to a data main body or a storage location of the advertisement content. The “billing unit price” is a billing amount per one impression in the case of the impression-guaranteed type advertisement content and is a billing amount which is set in accordance with a display time for one time display in the case of the time basis billing type advertisement content (for example, a billing amount which linearly or curvedly increases as the display time increases or a billing amount which is zero when the display time is shorter than a predetermined time and a predetermined amount when the display time exceeds the predetermined time, or billing amount set by combining these billing methods).

FIG. 3 is a diagram illustrating a structural example of data of the behavior history DB 322, which includes items such as a “user ID”, “behavior history data”, and an “expected display time”. The “user ID” is information which identifies a user and includes a member ID which may specifically identify the user and cookie (which is written as cookie information of a browser at the time of first access and referred at next access) which allows identification of accesses from the same browser. The “behavior history data” is a browsing history by the user (including a target advertisement content and date information). The “expected display time” is a time which is calculated based on the “behavior history data” and represents a time during which a page including the advertisement content is expected to be displayed by the user. Further, as will be described below, when the expected display time is calculated in view of the content (category) of the page including the advertisement content, the corresponding category is also specified and recorded. Further, the behavior history DB 322 may store, separately from the data of each user, expected display time for all user (including the expected display time calculated taking the category into consideration).

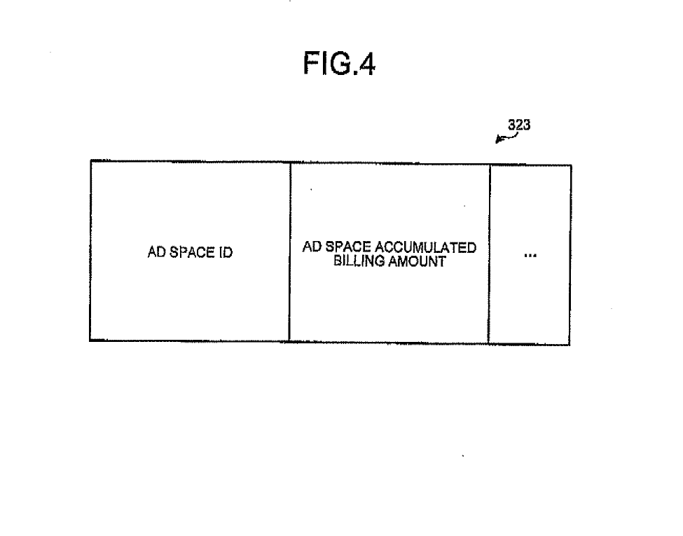

FIG. 4 is a diagram illustrating a structural example of data of the ad space DB 323, which includes items such as an “ad space ID” and “ad space accumulated billing amount”. The “ad space ID” is information which specifies the ad space. The “ad space accumulated billing amount” is an accumulated value of amounts which are charged for the advertisement content displayed on the ad space. For example, in the case of impression-guaranteed type advertisement content, billing unit price stored in the advertisement DB 321 is added for every display. In the case of the time basis billing type advertisement content, the billing unit price of the advertisement DB 321 is added in accordance with the display time.

Referring to FIG. 1, again, the advertisement content storing unit 301 of the page information/advertisement information providing device 3 has a function to store the advertisement ID, a type, and content data in the advertisement DB 321 for each piece of advertisement content provided from the advertiser at a predetermined timing.

The behavior history storing unit 302 has a function to monitor the browsing behavior of the user by the browser 21 of the terminal device 2 and to associate the user ID with the behavior history DB 322 to store the behavior history data.

The expected display time calculating unit 303 has a function to calculate the expected display time based on the behavior history data for every user and to store the calculated expected display time in the behavior history DB 322 by referring to the behavior history DB 322 at regular intervals or at a predetermined timing (for example, when the expected display time is required). The expected display time may be obtained by performing a statistical processing on the distribution of the display time per page extracted from the behavior history of the user (far example, the expected display time may be calculated merely as an average value of the data extracted from the behavior history or the expected display time with a certain reliability may be calculated by taking the deviation into account).

Further, instead of the expected display time for the user or together with the expected display time for the user, expected display time for all users may be calculated as a final expected display time. The expected display time for all users may be calculated by performing the statistical processing on the expected display times of all users. When both the expected display time of each user and the expected display time for all users are considered, an average of the two may be calculated as a final expected display time.

Further, the expected display time of one user, the expected display time for all users, or both, may be calculated for each category of the browsed page (including a case when a plurality of categories are included in one page). In this case, when the behavior history is referred, the display time is extracted for every category of the browsed page and the statistical processing is performed thereon.

For example, assume that the calculated, expected display time of a user A is:

Vehicle Category: 60 seconds;

Politics Category: 15 seconds; and

Entertainment gossip Category: 30 seconds.

Further, assume that a content of a page B is related with an attendance of an entertainer in an event presenting a new car, and the category of the page B is determined based on characteristic terms appear on the page B as:

Vehicle Category: 30%; and

Entertainment gossip Category: 70%.

In this case, an expected display time of the page B by the user A is calculated as

60×0.3+30×0.7=39 seconds.

Further, assume that the expected display time of the page B by all users is calculated as 50 seconds. If the expected display time of the user A and the expected display time for all users are to be considered, the final expected display time may be

(39+50)/2=44.5 seconds.

The ad space accumulated billing amount management unit 304 has a function to monitor the display of the advertisement content and the display time on the ad space and to update the ad accumulated billing amount in the ad space DB 323 for every advertisement content.

The page request receiving unit 305 has a function to receive a page browsing request from the browser 21 of the terminal device 2.

The page information generating unit 306 has a function to generate page information corresponding to the received page browsing request. The generated page includes an ad space.

The advertisement content type determining unit 307 has a function to determine which type of advertisement content, i.e., the impression-guaranteed type advertisement content or the time basis billing type advertisement content, is delivered when the page browsing request is received from the browser 21 of the terminal device 2. For example, when the expected display time does not exceed a predetermined threshold value, the display time is likely to be short and the time basis billing type advertisement is not suitable. In this case, the advertisement content type determining unit 307 determines to deliver the impression-guaranteed type advertisement content because fee can be charged irrespective of the display time as far as the content is displayed. On the other hand, when the expected display time exceeds the predetermined threshold value, the advertisement content type determining unit 307 determines to deliver the time basis billing type advertisement content because a high billing amount can be expected.

Further, the advertisement content type determining unit 307, when the advertisement content on the ad space of the page is updated at a predetermined time (for example, 20 seconds), determines types of a plurality of consecutive advertisement contents in accordance with the expected display time. The types of pieces of advertisement content which are sequentially updated on the ad space may be limited to the same type or may not be limited. For example, assume that an updating cycle is 20 seconds and the expected display time is 44.5 seconds. When the types of the pieces of the advertisement content to be displayed are limited to the same type, the advertisement content type determining unit 307 may determine to deliver the advertisement content of the time basis billing type for the first 20 seconds, the advertisement content of the time basis billing type for the next 20 seconds, and the advertisement content of the time basis billing type for the last 4.5 seconds. On the other hand, when the types of the pieces of the advertisement content to be displayed are not limited to the same type, the advertisement content type determining unit 307 may determine to deliver the advertisement content of the time basis billing type for the first 20 seconds, the advertisement content of the time basis billing type for the next 20 seconds, and the advertisement content of the impression-guaranteed type for the last 4.5 seconds.

The advertisement content determining unit 308 has a function to determine advertisement content to be delivered from more than one piece of the advertisement content stored in the advertisement DB 321 based on the type of advertisement content determined by the advertisement content type determining unit 307. The advertisement content determining unit 308 may determine the piece of advertisement content to deliver according to various methods; for example, the advertisement content determining unit 308 may pick up the piece randomly from pieces of advertisement content of the determined type, or the advertisement content determining unit 308 may pick up the piece based on usage rate or priority.

The advertisement content type determining unit 307 may not be included in the page information/advertisement information providing apparatus 3. When the advertisement content type determining unit 307 is not included, the advertisement content determining unit 308 may determine which piece of advertisement content to deliver by calculating the billing amount of each candidate piece of the advertisement content and selecting the piece with the highest billing amount. For example, assume that a billing amount of one piece of time basis billing type advertisement content is 0.1 Yen per one second and two Yen per 20 seconds or longer; and a billing amount of one piece of impression-guaranteed type advertisement content is one Yen per one impression. Further, assume that the expected display time is 44.5 seconds. If the advertisement content is not updated, when the piece of time basis billing type advertisement content is delivered, it is expected that the display may be performed for 20 seconds or longer so that the billing amount is two Yen. In contrast, if the piece of impression-guaranteed type advertisement content is delivered, the billing amount is one Yen. Therefore, the advertisement content determining unit 308 determines to deliver the piece of the time basis billing type advertisement content, which would results in a larger billing amount.

Assume that the content is updated for every 20 seconds, the types of pieces of displayed advertisement content are limited to the same type, and the billing condition is the same for pieces of advertisement content of the same billing type. In this case, if the pieces of the time basis billing type advertisement content are delivered, the billing amount is 2+2+0.45=4.45 Yen. On the other hand, if the pieces of the impression-guaranteed type advertisement content are delivered, the billing amount is 1+1+1=3 Yen. Therefore, the advertisement content determining unit 308 determines to deliver three pieces of time basis billing type advertisement content which will result in large billing amount.

Assume that the content is updated for every 20 seconds, the types of pieces of advertisement content is not limited to the same type, and the billing condition is the same for pieces of advertisement content of the same billing type. In this case, two pieces of time basis billing type advertisement content whose billing amount is larger than that of two pieces of impression-guaranteed type advertisement content are selected for the first 20 seconds and the next 20 seconds, and a piece of the impression-guaranteed type advertisement content whose billing amount is larger than that of a piece of the time basis billing type is selected for the last 4.5 seconds. In this case, the billing amount is 2+2+1=5 Yen.

The advertisement link embedding unit 309 has a function to embed a link to the advertisement content determined by the advertisement content determining unit 308 to the ad space of the page which is generated by the page information generating unit 306. The link is obtained by adding the advertisement ID to an URL of the page information/advertisement information providing device 3 as a parameter. Further, instead of embedding the link, the data of the advertisement content itself may be embedded in the page.

The page transmitting unit 310 has a function to transmit the page information to the browser 21 of the terminal device 2 which is a requesting source.

The advertisement request receiving unit 311 has a function to receive the request for the advertisement content based on the link which is embedded in the ad space in a process of rendering a screen using the page information by the browser 21 of the terminal device 2. When the data of the advertisement content itself is embedded in the ad space, the request for the advertisement content is not performed.

The advertisement transmitting unit 312 has a function to, when the advertisement request receiving unit 311 receives the request for the advertisement content, transmit data of the advertisement content to the browser 21 of the terminal device 2 which is the requesting source.

Operation: In a Case Where Type is Determined Based on Expected Display Time

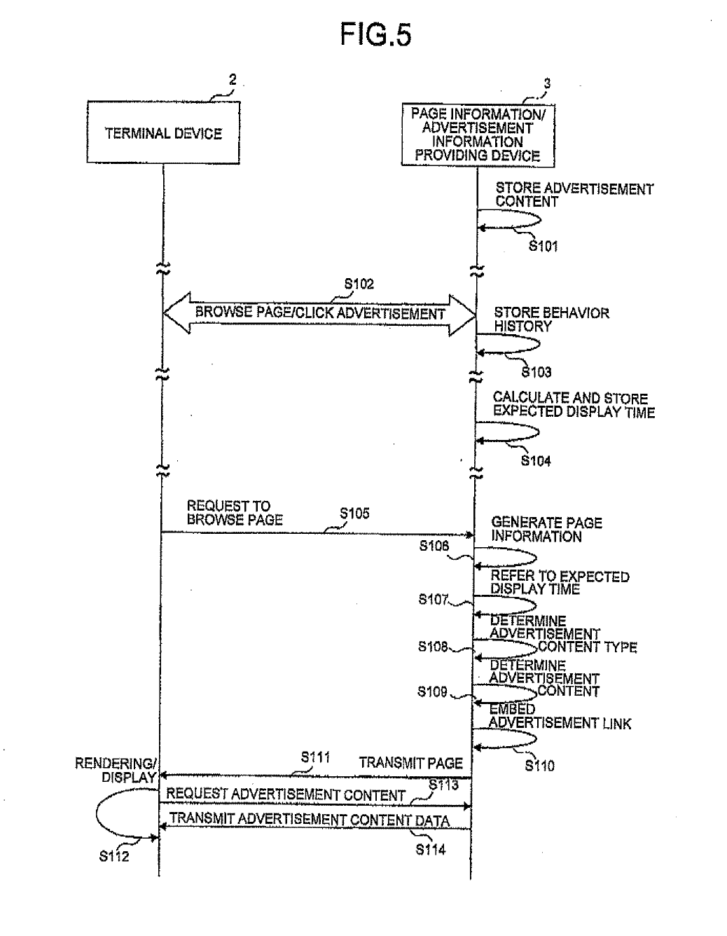

FIG. 5 is a sequential diagram illustrating a processing example of an embodiment.

Referring to FIG. 5, in step S101, the advertisement content storing unit 301 of the page information/advertisement information providing device 3 stores the advertisement ID, a type, and content data in the advertisement DB 321 for the advertisement content provided from the advertiser at a predetermined timing.

Next, if the page is browsed through the browser 21 of the terminal device 2 by the manipulation of the user in step S102, the behavior history storing unit 302 of the page information/advertisement information providing device 3 stores the behavior history data in the behavior history DB 322 so as to be associated with the user ID in step S103.

Next, in step S104, the expected display time calculating unit 303 of the page information/advertisement information providing device 3 calculates the expected display time based on the behavior history data for every user to store the calculated expected display time in the behavior history DB 322 by referring to the behavior history DB 322 at regular intervals or at a predetermined timing.

Next, if the page browsing request is sent from the browser 21 of the terminal device 2 and the page request receiving unit 305 of the page information/advertisement information providing device 3 receives the page browsing request in step S105, the page information generating unit 306 of the page information/advertisement information providing device 3 generates page information corresponding to the received page browsing request in step S106.

Next, the advertisement content type determining unit 307 of the page information/advertisement information providing device 3 refers to an expected display time in the behavior history DB 322 using the user ID of the user as a key in step S107 and determines which type of advertisement content, i.e., the impression-guaranteed type advertisement content or the time basis billing type advertisement content, is to be delivered in step S108.

Next, in step S109, the advertisement content determining unit 308 of the page information/advertisement information providing device 3 determines a piece of advertisement content to deliver from pieces of the advertisement content of the type determined by the advertisement content type determining unit 307 and stored in the advertisement DB 321.

When the advertisement content type determining unit 307 is not provided, in step S109, the advertisement content determining unit 308 determines delivery of which candidate piece among the pieces of advertisement content would result in a higher billing amount based on the expected display time, and determines the piece to deliver.

Next, in step S110, the advertisement link embedding unit 309 of the page information/advertisement information providing device 3 embeds a link to the advertisement content determined by the advertisement content determining unit 308 to the ad space of the page which is generated by the page information generating unit 306.

Next, in step S111, the page transmitting unit 310 of the page information/advertisement information providing device 3 transmits the page information to the browser 21 of the terminal device 2 which is the requesting source.

The browser 21 of the terminal device 2 receives the page information and displays a screen which is rendered based on the page information in step S112 and requests the advertisement content based on the link embedded in the ad space during the process in step S113.

When the advertisement request receiving unit 311 of the page information/advertisement information providing device 3 receives the request for the advertisement content, the advertisement transmitting unit 312 of the page information/advertisement information providing device 3 transmits the data of the advertisement content to the browser 21 of the terminal device 2 which is the requesting source in step S114. Further, the page is displayed and an advertisement delivery server may receive and deliver a redirect of the advertisement request from the ad space. Other operational examples are also similar.

Operation: In a Case Where Type is Determined Based on Ad space Accumulated Billing Amount and Expected Display Time

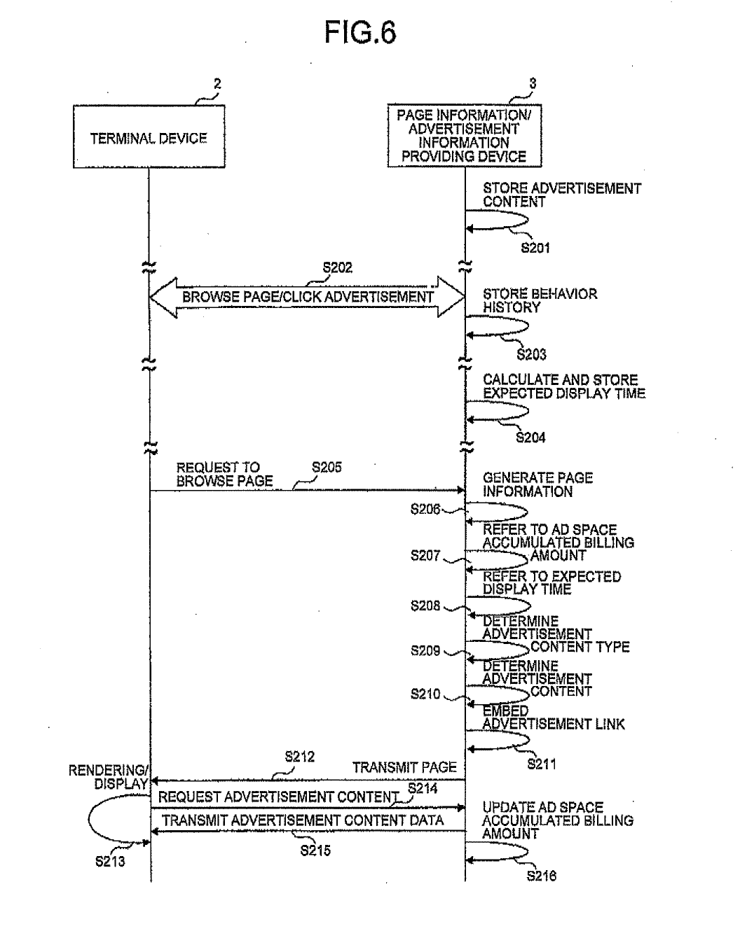

FIG. 6 is a sequential diagram illustrating a processing example of an embodiment.

Referring to FIG. 6, in step S201, the advertisement content storing unit 301 of the page information/advertisement information providing device 3 stores the advertisement ID, a type, and content data in the advertisement DB 321 for the advertisement content provided from the advertiser at a predetermined timing.

Next, if the page is browsed through the browser 21 of the terminal device 2 by the manipulation of the user in step S202, the behavior history storing unit 302 of the page information/advertisement information providing device 3 stores the behavior history data in the behavior history DS 322 so as to be associated with the user ID in step S203.

Next, in step S204, the expected display time calculating unit 303 of the page information/advertisement information providing device 3 calculates the expected display time based on the behavior history data for every user to store the calculated expected display time in the behavior history DB 322 by referring to the behavior history DB 322 at regular intervals or at a predetermined timing.

Next, if the page browsing request is sent from the browser 21 of the terminal device 2 and the page request receiving unit 305 of the page information/advertisement information providing device 3 receives the page browsing request in step S205, the page information generating unit 306 of the page information/advertisement information providing device 3 generates page information corresponding to the received page browsing request in step S206.

Next, in step S207, the advertisement content type determining unit 307 of the page information/advertisement information providing device 3 refers to an ad space accumulated billing amount in the ad space DB 323 using an ad space ID of the ad space as a key.

Here, if the ad space accumulated billing amount does not reach a predetermined accumulated billing amount, the advertisement content type determining unit 307 of the page information/advertisement information providing device 3 selects the impression-guaranteed type advertisement content in step S209 without performing the process of referring to the expected display time of step S208.

If the ad space accumulated billing amount exceeds a predetermined accumulated billing amount, the advertisement content type determining unit 307 of the page information/advertisement information providing device 3 refers to an expected display time in the behavior history DB 322 using the user ID of the user as a key in step S208 and determines which type of advertisement content, i.e., the impression-guaranteed type advertisement content or the time basis billing type advertisement content, is to be delivered in step S209.

Next, in step S210, the advertisement content determining unit 308 of the page information/advertisement information providing device 3 determines a piece of advertisement content to deliver from pieces of the advertisement content of the type determined by the advertisement content type determining unit 307 and stored in the advertisement DB 321.

When the advertisement content type determining unit 307 is not provided, in step S210, the advertisement content determining unit 308 determines delivery of which candidate piece among the pieces of advertisement content would result in a higher billing amount based on the expected display time, and determines the piece to deliver.

Next, in step S211, the advertisement link embedding unit 309 of the page information/advertisement information providing device 3 embeds a link to the advertisement content determined by the advertisement content determining unit 308 to the ad space of the page which is generated by the page information generating unit 306.

Next, in step S212, the page transmitting unit 310 of the page information/advertisement information providing device 3 transmits the page information to the browser 21 of the terminal device 2 which is the requesting source.

The browser 21 of the terminal device 2 receives the page information and displays a screen which is rendered based on the page information in step S213 and requests the advertisement content based on the link embedded in the ad space during the process in step S214.

When the advertisement request receiving unit 311 of the page information/advertisement information providing device 3 receives the request for the advertisement content the advertisement transmitting unit 312 of the page information/advertisement information providing device 3 transmits the data of the advertisement content to the browser 21 of the terminal device 2 which is the requesting source in step S215.

Next, in step S216, the ad space accumulated billing amount management unit 304 of the page information/advertisement information providing device 3 updates the ad space accumulated billing amount of the ad space DB 323 for every piece of advertisement content based on the display of the advertisement content and the display time on the ad space. In other words, the billing unit price of the advertisement DB 321 is added to the ad space accumulated billing amount for every impression in the impression-guaranteed type advertisement content, and the billing unit price of the advertisement DB 321 is added to the ad space accumulated billing amount in accordance with the display time in the time basis billing type advertisement content.

General Overview

As described above, according to the embodiment, the following advantages may be achieved.

(1) An advertisement content type is determined based on the expected display time. Hence, when the time basis billing type advertisement content is not suitable, the impression-guaranteed type advertisement content is selected because fee can be charged by mere presentation of the advertisement content irrespective of the display time. When the time basis billing type advertisement content is suitable, the time basis billing type is selected because higher billing amount can be expected in comparison with that of the impression-guaranteed type advertisement content. Thus, the billing amount for every ad space can be increased.

(2) The ad space accumulated billing amount is considered in determining the advertisement content type. When the ad space accumulated billing amount has not reached a predetermined accumulated billing amount, the impression-guaranteed type advertisement content is selected because fee can be charged by mere presentation of the advertisement content irrespective of the display time. After the ad space accumulated billing amount has reached the predetermined accumulated billing amount, the time basis billing type advertisement content is selected because higher billing amount can be expected in accordance with the expected display time. Thus, the billing amount for each ad space can be leveled.

According to an embodiment of the present invention, it is possible to increase a profit obtained by delivering the impression-guaranteed type advertisement content and the time basis billing type advertisement content in a mixed manner.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement information providing device, comprising:
an advertisement content storing unit which stores impression-guaranteed type advertisement content and time basis billing type advertisement content;
an advertisement content determining unit which, when receiving a page browsing request from a terminal device of a user, determines advertisement content to be delivered from the impression-guaranteed type advertisement content and the time basis billing type advertisement content stored in the advertisement content storing unit; and
an advertisement content delivering unit which delivers the advertisement content determined by the advertisement content determining unit to an ad space included in a page for which the page browsing request is received from the terminal device of the user.

2. The advertisement information providing device according to claim 1, further comprising:
a behavior history storing unit which stores a behavior history of the user for displayed advertisement; and
an expected display time calculating unit which calculates an expected display time of a page including an advertisement for every user based on the behavior history stored in the behavior history storing unit,
wherein the advertisement content determining unit, when receiving the page browsing request from the terminal device of the user, determines the advertisement content to be delivered from the impression-guaranteed type advertisement content and the time basis billing type advertisement content based on the expected display time of the user which is calculated by the expected display time calculating unit.

3. The advertisement information providing device according to claim 2, further comprising
a unit which manages an accumulated billing amount for every ad space,
wherein the advertisement content determining unit determines the impression-guaranteed type advertisement content as the advertisement content to be delivered to the ad space when the accumulated billing amount does not exceed a predetermined value, and determines one of the impression-guaranteed type advertisement content and the time basis billing type advertisement content as the advertisement content to be delivered based on the expected display time of the user calculated by the expected display time calculating unit when the accumulated billing amount exceeds the predetermined value.

4. A method which is executed by an advertisement information providing device, the method comprising:
storing impression-guaranteed type advertisement content and time basis billing type advertisement content;
determining, when receiving a page browsing request from a terminal device of a user, an advertisement content to be delivered from the impression-guaranteed type advertisement content and the time basis billing type advertisement content stored in the storing of the advertisement content; and
delivering the advertisement content determined in the determining of the advertisement content to an ad space included in a page for which the page browsing request is received from the terminal device of the user.
